(19) United States
(12) Patent Application Publication
(10) Pub. No.: US 2010/0102958 A1
(43) Pub. Date: Apr. 29, 2010

(54) Object tracking and locating apparatus

(75) Inventors: Ie Sen Chen, Taipei Hsien (TW); Chih Nung Chen, Taipei Hsien (TW); Wei Chia Huang, Taipei Hsien (TW)

Correspondence Address: CHARLES E. BAXLEY, ESQUIRE, 90 JOHN STREET, SUITE 309, NEW YORK, NY, 10038, US

(73) Assignee: Ardi Technology Corporation

(21) Appl. No.: 12/290,302

(22) Filed: Oct. 29, 2008

(51) Int. Cl. G08B 1/08

(52) U.S. Cl. 340/539.32

(57) ABSTRACT

An object tracking and locating device includes two or more identical units each having a receiving/transmitting module coupled to an antenna member for receiving and transmitting signals, a ZigBee wireless transmission module coupled to the receiving/transmitting module for processing the signals, and an alarm device coupled to the ZigBee wireless transmission module for generating a signal to indicate the spacing distance and the direction between the units, and the two or more identical units may be easily and quickly manufactured with a simplified manufacturing procedure and a reduced or decreased manufacturing cost.

### BACKGROUND OF THE INVENTION

1. Field of the Invention

The present invention relates to an object tracking and locating apparatus, and more particularly to an object tracking and locating apparatus including a simplified structure that may suitably reduce the manufacturing cost and that may be used to precisely track and locate an object to be found or monitored.

2. Description of the Prior Art

Typical object tracking and locating apparatuses or systems comprise a transmitter attached to the child or the object to be found or monitored, and a location monitoring device for monitoring the position of the child or the object to be found or monitored by detecting the signal strength of a radio frequency carrier from the transmitter.

For example, U.S. Pat. No. 5,289,163 to Perez et al. discloses one of the typical child position monitoring devices including a transmitter attached to or carried by the child or the object to be found or monitored, and a location monitoring device operated by an adult to monitor and to track and locate the position of the child or the object to be found or monitored.

However, the transmitter and the location monitoring device include two different mechanisms or structures formed by different electric circuits and parts or elements such that the manufacturing procedures for the typical child position monitoring devices will be complicated and such that the manufacturing cost for the typical child position monitoring devices will be increased.

U.S. Pat. No. 5,525,967 to Azizi et al. discloses another typical system and method for tracking and locating a person, a pet, an object or item of personal property by employing elements that enable the user to pinpoint both the distance and the direction of the person or object being monitored relative to the position of the monitoring or transmission unit.

However, similarly, the target transceiver unit and the monitoring or transmission unit include two different mechanisms or structures formed by different electric circuits and parts or elements such that the manufacturing procedures for the typical child position monitoring devices will be complicated and such that the manufacturing cost for the typical person or object tracking and locating system and method will be increased.

U.S. Pat. No. 7,260,360 to Seo et al. discloses a further typical multi-band ZigBee transceiver supporting IEEE 802.15.4 wireless communication including a multi-mode modem (MMM) for selecting any one of a European version standard using 860 MHz band, a US version standard using 920 MHz band, and a worldwide version standard using 2.4 GHz ISM band among IEEE 802.15.4 standards.

However, the typical multi-band ZigBee transceiver may not be used for easily tracking and locating a person, a pet, an object or item of personal property by employing elements that have simplified manufacturing procedures and that have a decreased manufacturing cost.

The present invention has arisen to mitigate and/or obviate the afore-described disadvantages of the conventional object tracking and locating apparatuses.

### SUMMARY OF THE INVENTION

The primary objective of the present invention is to provide an object tracking and locating apparatus including a simplified structure that may suitably reduce the manufacturing cost and that may be used to precisely track and locate an object to be found or monitored.

In accordance with one aspect of the invention, there is provided an object tracking and locating apparatus comprising a mother unit and a daughter unit including an identical structure and each including: an antenna member, a receiving/transmitting module electrically coupled to the antenna member for receiving and transmitting signals with the antenna member, a ZigBee wireless transmission module electrically coupled to the receiving/transmitting module for processing the signals from the receiving/transmitting module, and an alarm device electrically coupled to the ZigBee wireless transmission module for generating a warning signal, for allowing the two identical units to be easily and quickly manufactured with a simplified manufacturing procedure and to be produced with a greatly reduced or decreased manufacturing cost.

The receiving/transmitting module includes a receiving amplifier and a transmitting amplifier coupled between the ZigBee wireless transmission module and the antenna member for signal amplifying purposes.

The alarm device includes a buzzer for generating a sound signal, and/or includes at least one light emitting diode for generating a light signal, such as the flash lights or warning or alarm signals in series or in different sequences or in different brightness for indicating the distance between the mother and daughter units.

The ZigBee wireless transmission module includes a signal decoding module electrically coupled to the receiving/transmitting module for decoding the signals from the antenna member and the receiving/transmitting module.

The ZigBee wireless transmission module includes a frequency analysis and noise prevention module electrically coupled to the signal decoding module for filtering or eliminating or reducing the noises.

The ZigBee wireless transmission module includes a frequency locking module electrically coupled to the frequency analysis and noise prevention module for tracking the frequency for both of the mother and daughter units.

The ZigBee wireless transmission module includes a data analyzing and processing module electrically coupled to the frequency locking module for analyzing and processing the signals from the frequency locking module.

The ZigBee wireless transmission module further includes a timing control and power managing module electrically coupled between the data analyzing and processing module and the alarm device.

The data analyzing and processing module includes a signal collecting module electrically coupled to the frequency locking module for collecting signals. The data analyzing and processing module includes a data base module electrically coupled to the signal collecting module.

The data analyzing and processing module includes a relative vector comparing or mapping module electrically coupled to the data base module.

The ZigBee wireless transmission module includes a frequency setting module electrically coupled to the data analyzing and processing module. The ZigBee wireless transmission module includes a monitoring and analyzing module electrically coupled to the frequency setting module.

The ZigBee wireless transmission module includes a signal encoding module electrically coupled to the monitoring and analyzing module. The receiving/transmitting module includes a transmitting amplifier coupled between the signal encoding module of the ZigBee wireless transmission module and the antenna member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating an operation of an object tracking and locating apparatus in accordance with the present invention;

FIG. 2 is an exploded view illustrating the operation of the object tracking and locating apparatus;

FIG. 3 is a block diagram of the object tracking and locating apparatus;

FIG. 4 is another block diagram illustrating one of the monitoring devices of the object tracking and locating apparatus;

FIG. 5 is a further block diagram illustrating the detailed structure of the monitoring device; and

FIG. 6 is a flow chart illustrating the operation of the object tracking and locating apparatus.

### DETAILED DESCRIPTION OF THE PREFERRED EMBODIMENT

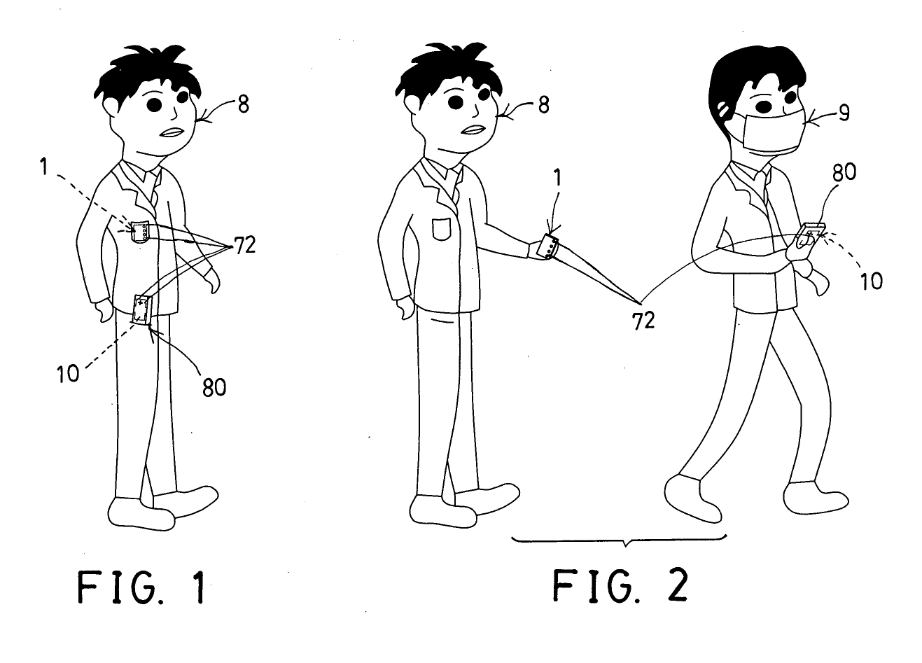

Referring to the drawings, and initially to FIGS. 1-3, an object tracking and locating apparatus in accordance with the present invention comprises a monitoring device or primary or mother unit 1, and one or more further monitoring devices or secondary or daughter units 10 to be attached to a person, a pet, an object 80 or item of personal property, such as a wallet or purse 80 as shown in FIGS. 1 and 2. For example, when the person or the pet is lost, or when the object or wallet or purse 80 has been stolen by a thief 9, the user 8 may use the primary or mother unit 1 to track and locate or monitor the secondary or daughter unit 10 that is attached or disposed in the object or wallet or purse 80.

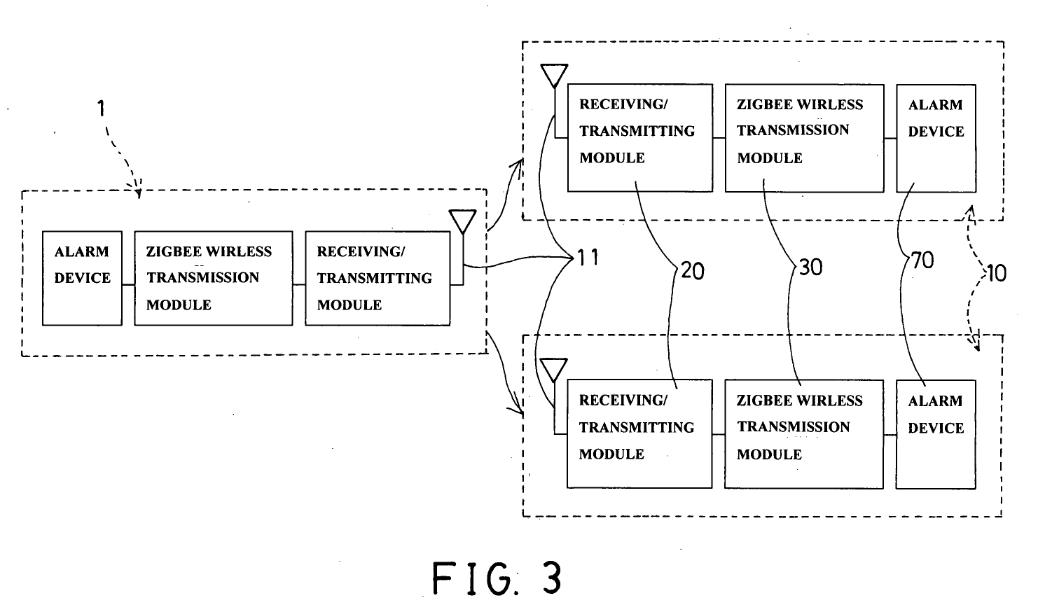

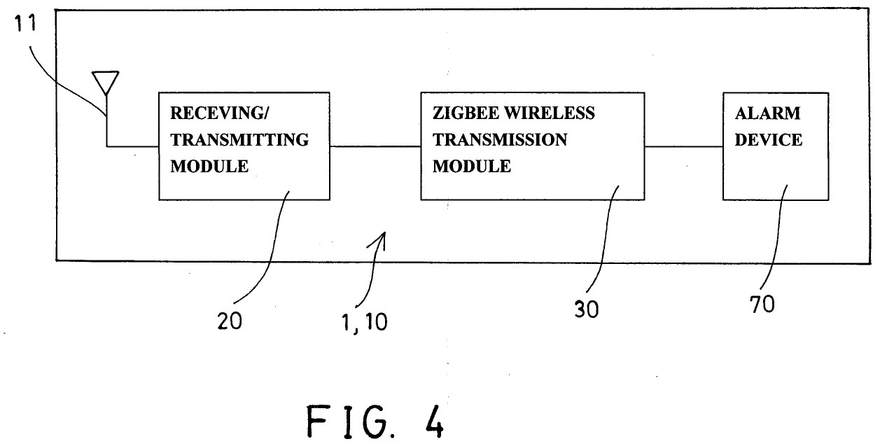

As shown in FIGS. 3-5, the primary or mother unit 1 and the secondary or daughter units 10 include an identical structure having an antenna member 11, a receiving/transmitting module 20 electrically coupled to the antenna member 11 for receiving signals from the antenna member 11 and/or for transmitting signals out through the antenna member 11, a ZigBee transceiver or wireless transmission module 30 electrically coupled to the receiving/transmitting module 20 for processing the signals from the receiving/transmitting module 20, and an alarm device 70 electrically coupled to the ZigBee wireless transmission module 30 for generating a warning signal. One example of the multi-band ZigBee transceivers for wireless communication has been disclosed in U.S. Pat. No. 7,260,360 to Seo et al. which may be taken as a reference for the present invention.

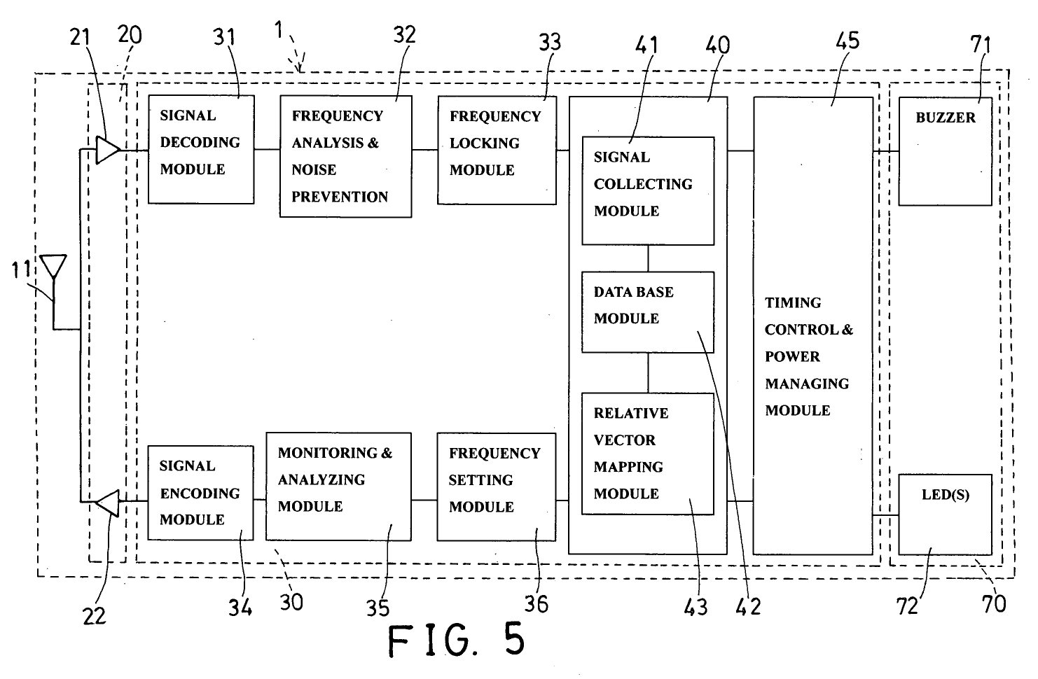

As shown in FIG. 5, the receiving/transmitting module 20 may include a receiving member or amplifier 21 for amplifying the signals from the antenna member 11, and a transmitting member or amplifier 22 for amplifying the signals from the receiving/transmitting module 20 and to be transmitted out through the antenna member 11. The alarm device 70 may include a buzzer 71 for generating a sound or alarm signal, and/or one or more light members or light emitting diodes (LED) 72 for generating a light or alarm signal. The ZigBee wireless transmission module 30 is electrically coupled between the receiving/transmitting module 20 and the alarm device 70 for processing the signals.

As also shown in FIG. 5, the ZigBee wireless transmission module 30 includes a signal decoding module 31 electrically coupled to the receiving member or amplifier 21 of the receiving/transmitting module 20 for decoding the signals from the antenna member 11 and the receiving member or amplifier 21, a frequency analysis and noise prevention module 32 electrically coupled to the signal decoding module 31 for filtering or eliminating the noises or the other interfering frequencies, and a frequency locking module 33 electrically coupled to the frequency analysis and noise prevention module 32 for tracking or locking the frequency for both the primary or mother unit 1 and the secondary or daughter units 10.

The ZigBee wireless transmission module 30 further includes a signal data analyzing and processing module 40 electrically coupled to the frequency locking module 33 for analyzing and processing the signals from the frequency locking module 33 and the frequency analysis and noise prevention module 32 and the signal decoding module 31 and the receiving member or amplifier 21 and the antenna member 11 and from the primary or mother unit 1 or the secondary or daughter units 10. For example, the data analyzing and processing module 40 includes a signal collecting module 41 and a data base module 42 and a relative vector comparing or mapping module 43 electrically coupled together in series.

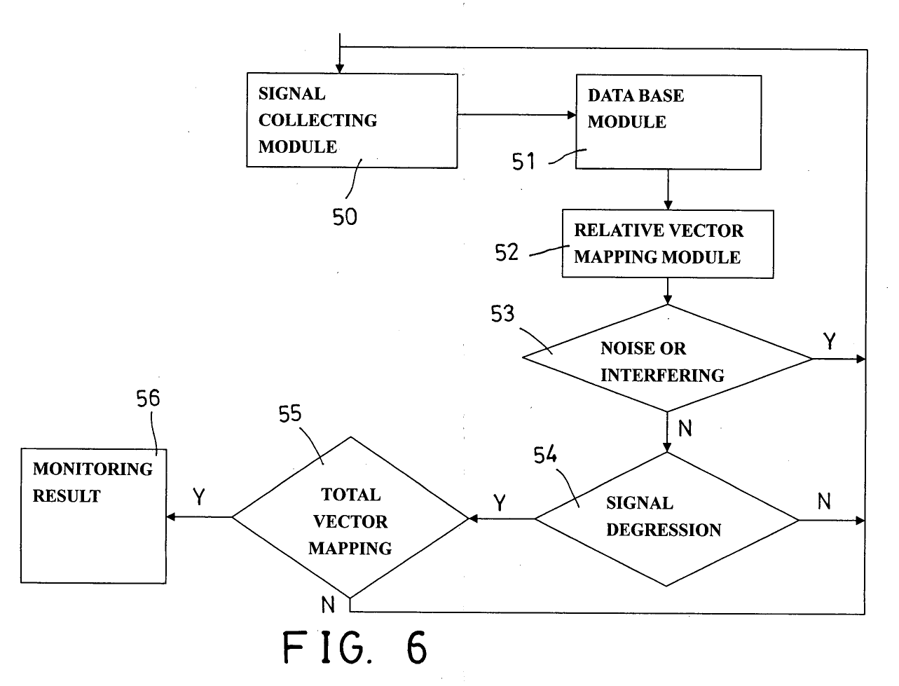

For example, the signal collecting module 41 is electrically coupled to the frequency locking module 33 for collecting the signals from the frequency locking module 33, the data base module 42 is electrically coupled to the signal collecting module 41 for storing or memorizing the collected signal data base, and the relative vector comparing or mapping module 43 is electrically coupled to the data base module 42 for signal comparing or mapping purposes. In operation, as shown in FIG. 6, the signals from the frequency locking module 33 may be sent to the signal collecting module 41 and the data base module 42 and the relative vector comparing or mapping module 43 in the processes 50, 51, 52.

The relative vector comparing or mapping module 43 may then compare or map the newly received or incoming signal data with the signal data stored or memorized in the data base module 42 in the process 53 to determine if the newly received or incoming signal data is a noise or an interfering signal or not. When the newly received or incoming signal data has been determined as a noise or an interfering signal, the newly received or incoming signal data will be ignored and will be returned to the signal collecting module 41 for further collecting the signals from the frequency locking module 33. When the newly received or incoming signal data has been determined as not a noise or an interfering signal, the newly received or incoming signal data will be compared with the signal data stored or memorized in the data base module 42 to detect the signal or vector degression or decreasing in the process 54.

When the signal or vector is not a degression or decreasing value, the procedure will be returned to the signal collecting module 41 for further collecting the signals from the frequency locking module 33. On the contrary, when the signal or vector has been detected or determined as a degression or decreasing value, the total signal or vector will be compared or mapped to determine whether the total vector is corrected or not in the process 55. If the total signal or vector has been detected or determined to be not correct, the procedure will be returned to the signal collecting module 41 for further collecting the signals from the frequency locking module 33. On the contrary, when the total signal or vector has been detected or determined to be correct, a monitoring result will be obtained in the process 56 to determine that the total signal or vector is correct.

Referring again to FIG. 5, the ZigBee wireless transmission module 30 further includes a timing control and power managing module 45 electrically coupled to the signal data analyzing and processing module 40 for receiving the monitoring result from the relative vector comparing or mapping module 43 of the signal data analyzing and processing module 40, and for actuating or operating the light members or light emitting diodes (LEDs) 72 to generate the flash lights or alarm signals when the total signal or vector has been detected or determined to be correct.

The ZigBee wireless transmission module 30 further includes a frequency setting module 36 electrically coupled to the signal data analyzing and processing module 40 and/or the timing control and power managing module 45 for receiving the signals from the signal data analyzing and processing module 40 and/or the timing control and power managing module 45 and for allowing the signals or information or data to be suitably transmitted between the primary or mother unit 1 and the secondary or daughter units 10. The ZigBee wireless transmission module 30 further includes a monitoring and analyzing module 35 electrically coupled to the frequency setting module 36, and a signal encoding module 34 electrically coupled to the monitoring and analyzing module 35 and the transmitting member or amplifier 22.

The frequency setting module 36 may suitably set the frequency for both the primary or mother unit 1 and the secondary or daughter units 10 for allowing the signals or information or data to be suitably and correctly transmitted between the primary or mother unit 1 and the secondary or daughter units 10, the monitoring and analyzing module 35 may automatically track or monitor and analyze the frequency or the address of both the primary or mother unit 1 and the secondary or daughter units 10, and the signal encoding module 34 may encode the signals or information or data and may send the encoded signals or information or data to the transmitting member or amplifier 22 and then for transmitting the encoded signals or information or data to the other secondary or daughter units 10 or the other primary or mother unit 1 through the antenna member 11.

In operation, as shown in FIG. 2, for example, when the object or wallet or purse 80 has been stolen by a thief 9 and moved away from the user 8, the distance between the object or wallet or purse 80 and the user 8 or the distance between the primary or mother unit 1 and the secondary or daughter units 10 will be increased, and the signal strength received or transmitted between the primary or mother unit 1 and the secondary or daughter units 10 will be decreased relatively. The signal collecting module 41 and/or the data base module 42 and/or the relative vector comparing or mapping module 43 of the data analyzing and processing module 40 may then track or compare or map to determine whether the secondary or daughter units 10 or the purse 80 or the thief 9 has been moved away from the user 8 or the primary or mother unit 1 for a predetermined distance or not.

When the secondary or daughter units 10 or the purse 80 or the thief 9 is still located within the predetermined distance from the user 8 or the primary or mother unit 1, the timing control and power managing module 45 of the signal data analyzing and processing module 40 may actuate or operate the light members or light emitting diodes (LEDs) 72 to generate the flash lights or alarm signals in series or in different sequences or in different brightness and to indicate whether the primary or mother unit 1 is aimed or directed toward the secondary or daughter units 10 or not, and to indicate whether the primary or mother unit 1 is moving closer or farther away from the secondary or daughter units 10, and thus for allowing the object or wallet or purse 80 to be easily tracked and located.

When the secondary or daughter units 10 or the purse 80 or the thief 9 has been moved away from the user 8 or the primary or mother unit 1 more than the predetermined distance, the timing control and power managing module 45 of the signal data analyzing and processing module 40 may actuate or operate the buzzer 71 to generate the sound or alarm signals and to indicate that the secondary or daughter units 10 or the purse 80 or the thief 9 has been moved away from the user 8 or the primary or mother unit 1 for more than the predetermined distance, and to allow the user to track and locate the purse 80 or the thief 9 right away.

It is to be noted that the primary or mother unit 1 and the secondary or daughter units 10 include an identical structure having an antenna member 11, a receiving/transmitting module 20 for receiving and/or transmitting signals, a ZigBee wireless transmission module 30 for processing the signals from the receiving/transmitting module 20, and an alarm device 70 for generating a sound or light warning signal, such that the primary or mother unit 1 and the secondary or daughter units 10 having the same structure may be easily and quickly manufactured with a simplified manufacturing procedure and a reduced or decreased manufacturing cost.

Accordingly, the object tracking and locating apparatus in accordance with the present invention includes a simplified structure that may reduce the manufacturing cost and that may be used to precisely track and locate an object to be found or monitored.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An object tracking and locating apparatus comprising:
a mother unit and a daughter unit including an identical structure and each including:
an antenna member,
a receiving/transmitting module electrically coupled to said antenna member for receiving and transmitting signals with said antenna member,
a ZigBee wireless transmission module electrically coupled to said receiving/transmitting module for processing the signals from said receiving/transmitting module, and
an alarm device electrically coupled to said ZigBee wireless transmission module for generating a warning signal.

2. The object tracking and locating apparatus as claimed in claim 1, wherein said receiving/transmitting module includes a receiving amplifier and a transmitting amplifier coupled between said ZigBee wireless transmission module and said antenna member.

3. The object tracking and locating apparatus as claimed in claim 1, wherein said alarm device includes a buzzer for generating a sound signal.

4. The object tracking and locating apparatus as claimed in claim 1, wherein said alarm device includes at least one light emitting diode for generating a light signal.

5. The object tracking and locating apparatus as claimed in claim 1, wherein said ZigBee wireless transmission module includes a signal decoding module electrically coupled to said receiving/transmitting module for decoding the signals from said antenna member and said receiving/transmitting module.

6. The object tracking and locating apparatus as claimed in claim 5, wherein said ZigBee wireless transmission module includes a frequency analysis and noise prevention module electrically coupled to said signal decoding module for eliminating noises.

7. The object tracking and locating apparatus as claimed in claim 6, wherein said ZigBee wireless transmission module includes a frequency locking module electrically coupled to said frequency analysis and noise prevention module for frequency tracking purposes.

8. The object tracking and locating apparatus as claimed in claim 7, wherein said ZigBee wireless transmission module includes a data analyzing and processing module electrically coupled to said frequency locking module for analyzing and processing the signals from said frequency locking module.

9. The object tracking and locating apparatus as claimed in claim 8, wherein said ZigBee wireless transmission module includes a timing control and power managing module electrically coupled between said data analyzing and processing module and said alarm device.

10. The object tracking and locating apparatus as claimed in claim 8, wherein said data analyzing and processing module includes a signal collecting module electrically coupled to said frequency locking module for collecting signals.

11. The object tracking and locating apparatus as claimed in claim 10, wherein said data analyzing and processing module includes a data base module electrically coupled to said signal collecting module.

12. The object tracking and locating apparatus as claimed in claim 11, wherein said data analyzing and processing module includes a relative vector comparing or mapping module electrically coupled to said data base module.

13. The object tracking and locating apparatus as claimed in claim 7, wherein said ZigBee wireless transmission module includes a frequency setting module electrically coupled to said data analyzing and processing module.

14. The object tracking and locating apparatus as claimed in claim 13, wherein said ZigBee wireless transmission module includes a monitoring and analyzing module electrically coupled to said frequency setting module.

15. The object tracking and locating apparatus as claimed in claim 14, wherein said ZigBee wireless transmission module includes a signal encoding module electrically coupled to said monitoring and analyzing module.

16. The object tracking and locating apparatus as claimed in claim 15, wherein said receiving/transmitting module includes a transmitting amplifier coupled between said signal encoding module of said ZigBee wireless transmission module and said antenna member.
